(19) United States
(12) Patent Application Publication
(10) Pub. No.: US 2015/0161399 A1
(43) Pub. Date: Jun. 11, 2015

(54) STORAGE MODULE WITH AUTHENTICATED STORAGE ACCESS

(71) Applicant: Memory Technologies LLC, Las Vegas, NV (US)

(72) Inventor: Kimmo Juhani Mylly, Ylojarvi (FI)

(21) Appl. No.: 14/566,566

(22) Filed: Dec. 10, 2014

Related U.S. Application Data
(60) Provisional application No. 61/914,284, filed on Dec. 10, 2013.

(51) Int. Cl. G06F 21/60

(52) U.S. Cl. CPC G06F 21/60

(57) ABSTRACT

A storage module includes a mass storage. The storage module may also include a first register configured to define a portion of the mass storage, a key associated with the portion of the mass storage, a receiver configured to receive data to be stored in the portion of the mass storage wherein the received data includes signature data based on the key, and an authentication circuit to authenticate the signature data. A controller of the storage module is configured to program data from the received data in the portion of the mass storage in response to the signature data being authenticated based on the key, and to deny programming of data to the portion of the mass storage in response to the signature data not being authenticated.

### RELATED APPLICATIONS

The present application claims priority to U.S. Provisional Application No. 61/914,284, filed Dec. 10, 2013, and entitled “Storage Module with Authenticated Storage Access,” the entirety of which is incorporated herein in its entirety. This application is related to U.S. application Ser. No. 12/455,763, filed Jun. 4, 2009, now patented as U.S. Pat. No. 8,874,824, U.S. application Ser. No. 12/443,481, filed Jun. 23, 2010, and U.S. application Ser. No. 11/176,669, filed Jul. 8, 2005, now patented as U.S. Pat. No. 7,827,370, each of which are assigned to the assignee of the present application. Each of these related applications are incorporated herein by reference in their entireties.

### BACKGROUND

Managed storage modules, such as managed NAND storage modules, provide many benefits over using raw memories such as flash NAND memories. Managed storage modules, which typically include a storage controller combined with NAND memory in the case of managed NAND or other types of memory in other cases, provide several benefits to device manufacturers. The storage controller hides the details of the memory (e.g., NAND) and provides the intended interface and other features, such as error-correcting code (ECC) support without the device manufacturers having to implement those features on the host side (e.g., a smartphone or a tablet). Additionally, managed storage modules allow new advanced features to be implemented in the storage controller without the host necessarily having to even be aware that the features exist. The advanced features can either be activated or not by the storage controller depending on whether the host supports the features. Thus, managed storage modules improve backwards compatibility.

Examples of managed storage modules, and in particular managed NAND storage modules, include embedded multimedia cards (eMMC), universal flash storage (UFS), solid-state drive (SSD) modules. These modules are used in wide variety of applications like mobile phones, Global positioning system (GPS) devices, media players, PCs, and servers for storing the operating system code, applications, and user data, such as, photos and videos. Along with the data visible to the host device, operational code/firmware (FW) of the storage module itself is stored in the memory of the storage module. Additionally, other important data, which is needed to operate the storage module, such as register data and address translation data, may be stored in the memory.

The operating system (OS) code on the storage module may need security to prevent any malware from modifying it. One kind of protection could be a permanent write protection of portions of the memory where the OS code is stored. Some standards, such as JEDEC JESD84 for eMMC, include an option to write protect parts of a memory either permanently or until power is reset or cycled.

Occasionally during the lifetime of a device there may emerge a need to update the OS code of the host device or operational code/firmware (FW) of the storage module. One such description can be found from U.S. application Ser. No. 12/443,481, filed as PCT No. PCT/IB2006/003872 on Jun. 23, 2010, which is hereby incorporated by reference in its entirety. This disclosure includes a description of an update process of operating code in a storage module so that potential write protection of the portion of the memory is overridden for the period of the update procedure. Similar to when updating the OS code, operational code/firmware may need to be protected from inadvertent modification or modification by malware.

### BRIEF DESCRIPTION OF THE DRAWINGS

FIG. 1 depicts an example host device.

FIG. 2 depicts an embodiment of a storage module.

FIG. 3 depicts a process flow of a first embodiment of the invention.

The figures depict embodiments of the present invention for purposes of illustration only. One skilled in the art will readily recognize from the following discussion that alternative embodiments of the structures and methods illustrated herein can be employed without departing from the principles of the invention described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

As discussed above, managed storage modules may store OS code for a host device and/or operational/firmware code for a storage module. These pieces of code, data, or other information may be particularly sensitive to modification by malware. For example, if malware is able to modify these types of information, then the security of the host device using the storage module may be compromised. Some storage standards, such as those that define eMMC, allow for permanent or temporary (i.e., until power is reset) write protection of definable portions of storage. A description of this procedure may be found in U.S. Pat. No. 7,827,370, filed on Jul. 8, 2005, which is hereby incorporated by reference in its entirety.

Using the permanent write protection option provides adequate security. However, as discussed above, sometimes it may be necessary to update the OS code or the operational/firmware code after those codes have already been stored in the storage module in regions that have already been permanently write protected. In these cases, it would be helpful to still be able to update the codes if the new codes can be authorized or verified as being authentic. Accordingly, embodiments of the invention discussed below determine that data is authentic prior to allowing that data to be written to protected areas of the storage module. Moreover, embodiments of the invention discussed below also determine that the identity of the source of the data to be written is authentic (e.g., verification that the data received came from trusted source and/or from a source aware of a shared secret key).

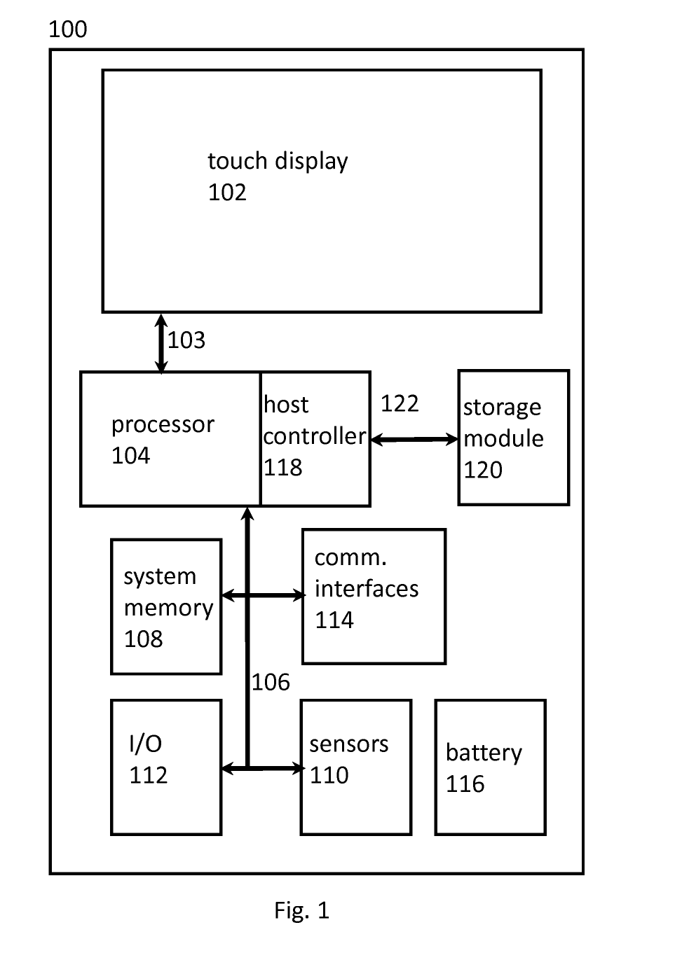

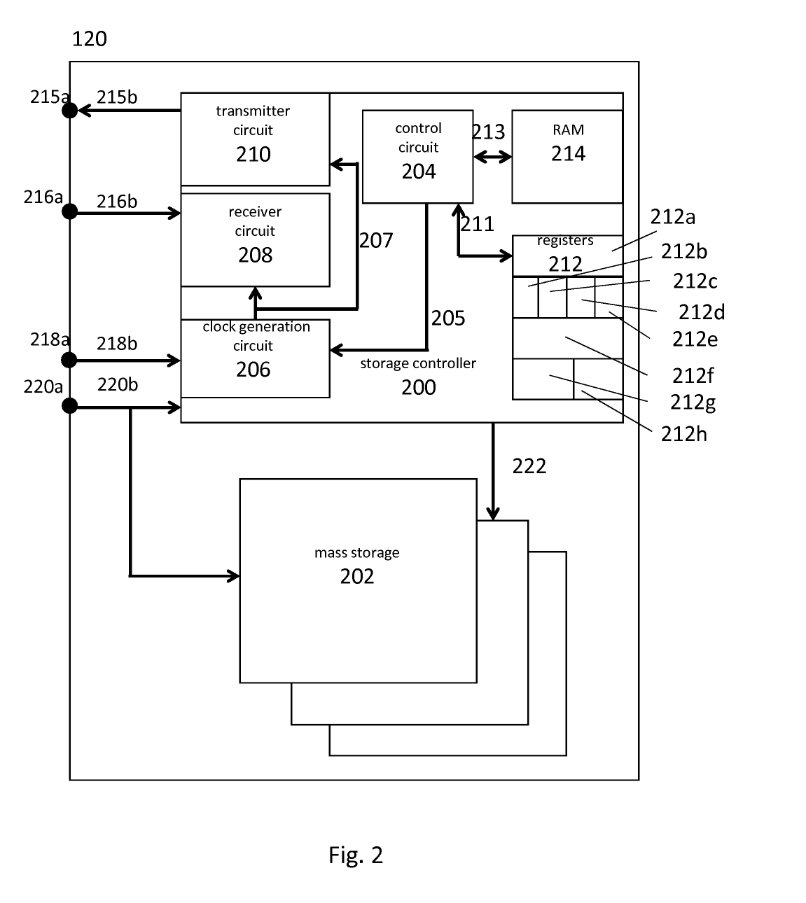

FIG. 1 depicts an example host device 100, e.g., a smartphone or a tablet, that may utilize embodiments of the present invention. Host device 100 includes a touch display 102 that is sensitive to a user's touch based on capacitive or resistive detection. Bus 103 connects touch display 102 to processor 104, which may include a graphics subsystem that handles the display of graphics and text on touch display 102. Host device 100 also includes a number of other components connected to processor 104 through shared bus 106, including system memory 108 (e.g., DRAM), sensors 110 (e.g., accelerometers, gyroscope, GPS), input/output (I/O) 112 (e.g., a speaker, a microphone, or a keyboard), and communications interfaces 114 (e.g., USB, WiFi, Bluetooth, or other wired or wireless interfaces). Processor 104 may also include a host controller 118 (which may be alternatively connected to but is separate from processor 104) that interfaces with storage module 120 over bus 122. Alternatively, host controller 118 may interface with storage module 120 over shared bus 106. As discussed herein, the storage module 120 (may also be referred to as a storage device or a memory device) is configured to determine that data is authentic prior to allowing that data to be written to protected areas of the storage module. Both shared bus 106 and bus 122 may include several bus lines for data, commands, clocking signals, power, reset, etc. An example of the bus lines included in bus 122 is described below with respect to FIG. 2. Battery 116 provides power to the above described components through a power supply bus and/or lines (not shown).

While the use of storage module 120 is shown in the context of a touch sensitive smartphone or tablet, the present invention is not limited to use in such devices. Embodiments of the present invention may be applied to any electronic device that requires storage, e.g., wearable computers such as smartwatches or glasses, televisions, cameras, netbooks, gaming consoles, personal computers, servers, set top boxes, and the like. Additionally, the architecture of host device 100 is provided for illustrative purposes only and should not be considered limiting.

FIG. 2 depicts an exemplary architecture for storage module 120 that may implement embodiments of the present invention. Storage module 120 may be contained within a package (e.g., a ball grid array (BGA) package) that is designed to be mounted on a printed circuit board. For example, storage module 120 may be an embedded MultiMediaCard (eMMC) or universal flash storage (UFS) module. Alternatively, storage module 120 may be contained within a removable card that fits within a slot on the host device or a semi-removable device such as an SSD module or PC/server cards/modules (e.g., PCIe cards). Additionally, although storage module 120 is shown as being one self-contained device, storage module 120 may also be implemented with a collection of interconnected devices.

As shown in FIG. 2, storage module 120 includes storage controller 200 for communicating data between mass storage 202 and host 100 (see FIG. 1). Storage controller 200 includes control circuit 204 for controlling the operation of storage controller 200. Control circuit 204 may be connected to RAM 214 over bus 213 for storing operating information and/or for providing temporary storage as required by storage module 120. Storage controller 200 also includes clock generation circuit 206 for generating an internal clocking signal on internal clock bus 207, receiver circuit 208 (may be referred to herein as “receivers”) for receiving data and commands from host controller 122 (see FIG. 1), transmitter circuit 210 for transmitting data and status information to host controller 122 (see FIG. 1), and registers 212 for storing information and settings relating to the operation of storage module 120, including information related to the generation of the internal clocking Control circuit 204 may use bus 211 to access, or write information to, registers 212. Storage module 120 communicates with host controller 118 through data out line 215b and data terminal 215 a, which may provide data and status information, and data in line 216b and data terminal 216a, which may provide data, commands, and status information.

Storage module 120 also includes reference clock line 218b and reference clock terminal 218a that provide a reference clock signal to clock generating circuit 206, and power line 220b and power terminal 220a that provide power to storage controller 200 and mass storage 202. While the above lines and terminals are shown to be single lines and terminals in FIG. 2, each line and terminal may be made up of multiple lines and terminals. For example, power terminal 220a may include multiple terminals associated with multiple lines of power line 220b that each individually provide power to the different components (e.g., mass storage 202 and storage controller 200). As another example, data out line 215b and data out terminal 215a or data in line 216b and data in terminal 216a may be implemented using two lines (e.g., a differential pair or a 2-bit wide bus) connected to two terminals. Bus 222 allows for storage controller 200 to read data from, and write data to, mass storage 202.

Storage module 120 also includes mass storage 202, which includes one or more memory blocks on one or more memory planes/banks, which may be on one or more chips having memory circuits or cells for storing one or more bits of information. For example, mass storage 202 may be implemented with a non-volatile memory such as NAND flash memory having memory cells/circuits (e.g., NAND cells) each capable of storing one bit (single-level cell) or multiple bits (multi-level cell) of data. Other forms of non-volatile memory can also be used without departing from the present invention. For example, non-volatile memory may include phase change memory (PCM), magneto-resistive random-access memory (MRAM), resistive random-access memory (RRAM), ferroelectric random-access memory (FRAM), and so forth.

In various implementations, mass storage 202 includes a plurality of addressable memory locations that are each associated with at least one memory cell, a byte, a word or multiple of words. Thus, an addressable memory location may comprise at least one memory plane/blank, at least one memory block, at least one memory page, and so forth. One or more addressable memory locations may also comprise a region or portion of memory, as discussed herein. An address may be a logical address or a physical address.

Mass storage 202 may be physically and/or logically divided. For example, mass storage 202 may be implemented as a single chip. Alternatively, mass storage 202 may be implemented with several discrete chips that are connected together in a single package (as shown in FIG. 2) or, alternatively, separately packaged and externally connected together. Mass storage 202 may also be divided up into planes/banks which may be further divided into blocks, which may be even further divided into pages. Storage controller 200 is connected to mass storage 202 through bus 222, which allows for storage controller 200 to read data from, and write data to, mass storage 202.

RAM 214 is a memory that storage controller 200 uses to store operating information (e.g., operating code and/or state information) that may need to be readily/quickly accessed. For example, RAM 214 may store a translation table that describes how logical addresses are mapped to physical addresses of mass storage 202. When RAM 214 is not implemented or not enough RAM 214 is implemented within storage module 120, in some cases, storage controller 200 may instead request and use a portion of system memory 108 of host 100 (see FIG. 1), as described in U.S. patent application Ser. No. 12/455,763, filed on Jun. 4, 2009, which is incorporated by reference in its entirety.

Clock generation circuit 206 may be implemented with a circuit that is capable of generating a clock signal. For example, clock generation circuit 206 may be implemented using common clock recovery and/or generation circuits including PLLs, oscillators, voltage controlled oscillators, delay locked loops, frequency detectors, frequency multipliers/dividers, phase detectors, combinations of these circuits, or any other suitable circuit. Clock generation circuit 206 may also rely on other components, such as resistors, capacitors, inductors, crystals, or MEMS devices. Clock generation circuit 206 may also be programmable so that it can provide a clocking signal output that varies according to the inputs that it receives. For example, clock generation circuit 206 may be configured to produce a clocking signal of a very high quality (e.g., low jitter) when a reference clock signal is present on reference clock line 218b. Clock generation circuit 206 may also be configured to produce a clocking signal of a lower quality when a reference clock signal is absent. As other examples, the frequency, duty cycle, jitter, output skew, or propagation delay of the outputted clocking signal may be set according to inputs (e.g., control bits) that are provided to clock generation circuit 206 through bus 205. In alternative architectures, clock generation circuit 206 have direct access to registers 212 without going through control circuit 204 or clock generation circuit 206 could have a register internal to itself for storing clock configuration information. While clock generation circuit 206 is shown to be part of storage controller 200, clock generation circuit 206 may also be implemented external to storage controller 200 without departing from the present invention.

Receiver circuit 208 and transmitter circuit 210 receive the internal clock signal on internal clock line 207 so that storage module 120 may transfer data to host 100 at higher rates than without a clock signal. In another embodiment, internal clock line 207 only provides the internal clock signal to the receiver circuit 208, but not to the transmitter circuit 210. In yet another embodiment, internal clock line 207 only provides the internal clock signal to the transmitter circuit 210, but not to the receiver circuit 208.

Registers 212 store one or more bits of information regarding the operation of storage module 120, including information regarding the operation of clock generation circuit 206 or other features of storage module 120. Registers 212 may be implemented as part of storage controller 200, as part of mass storage 202, as part of RAM 214, or as part of some other memory circuit in storage module 120. The memory used for registers 212 may be any type. For example, registers 212 may be implemented in volatile (e.g., SRAM, DRAM), non-volatile (flash, magnetic, resistive), ROM, one time programmable, or any combination of different types of memory.

Registers 212 may include several individual registers, e.g., registers 212a-212h of similar or different sizes. For example, register 212a may be a 1-byte register while registers 212b-212e are 1-bit registers and register 212f is a 4-byte register. Registers 212 can be used to store several specific types of information. In one case, some of registers 212 store read-only information that describes how storage module 120 operates (e.g., supported features) or requirements for storage module 120 to properly operate or operate at different levels of performance (e.g., current requirements for different transfer rates). In another case, some of registers 212 store writeable information that configures how storage module 120 operates or what storage module 120 needs to operate. In yet another case, some of registers 212 store information about how storage module 120 is currently operating or the current state of storage module 120. Together, registers 212 may also store all of the different types of information described above along with other types of data. Registers 212 may also be used to implement descriptors, flags, and attributes as described in JEDEC Standard No. 220A for Universal Flash Storage (UFS 1.1), published June 2012, which is incorporated by reference herein in its entirety.

In one case, registers 212 store information that describes a region of mass storage 202 that is write protected (either permanently or temporarily). For example, register 212f may define an address range, a block range, a partition, or the like that defines the region. Another register, e.g. register 212g, may define whether the region is permanently write protected, temporarily write protected, or authenticated write protected. In the case of permanent write protection or temporary write protection, the region is protected as described in U.S. Pat. No. 7,827,370, which was incorporated by reference above. However, in the case of the region being authenticated write protected, the region may be written to, e.g., programmed, if authentication of the data to be written is successful. Implementation of this feature is discussed below with respect to various embodiments of the invention.

Control circuit 204 may include a state machine or several state machines. Alternatively, as another example, control circuit 204 may include a general purpose processor or microcontroller that is programmed to control storage module 120. For example, a processor programmed with firmware may implement one or more state machines that govern the operation of storage module 120. Firmware or other software for programming control circuit 204 may be stored in dedicated storage or in a reserved storage area on mass storage 202. As another alternative, control circuit 204 may be implemented as a combination of a general purpose processor programmed with firmware or the like and special purpose circuitry that perform specific functions.

Among the aspects of storage module 120 that control circuit 204 controls is the operation of clock generation circuit 206. In particular, using information stored in registers 212 and state information, which, in some examples, may also be stored in registers 212 or alternatively in RAM 214, control circuit 204 supplies control information (e.g., control bits) to clock generation circuit 206 that can control the operation of the internal clock signal.

Other functions of control circuit 204 include receiving command signals, e.g., via receiver circuit 208, from host 100 to perform certain functions. For example, control circuit 204 may receive command signals from host 100 to read information from, or write information to, registers 212. For instance, control circuit 204 may receive a command to read registers 212 in a location that stores a state of storage module 120 (e.g., a power state, a programming state, etc.).

It should be understood that the architecture of FIG. 2 is an example for ease of discussion only and should not be considered limiting on the invention. Circuits, buses, lines, modules and the like may have been simplified, left out, or otherwise combined with other components in FIG. 2. For example, storage module 120 is shown to have buses 207, 205, 213, 211, and 222. These buses may be removed, combined, rerouted, and/or added to without departing from the spirit of the invention described herein. As another example, the functionality of control circuit 204 may be greatly expanded over what is described above or the functions described above by control circuit 204 may be spread across different circuits.

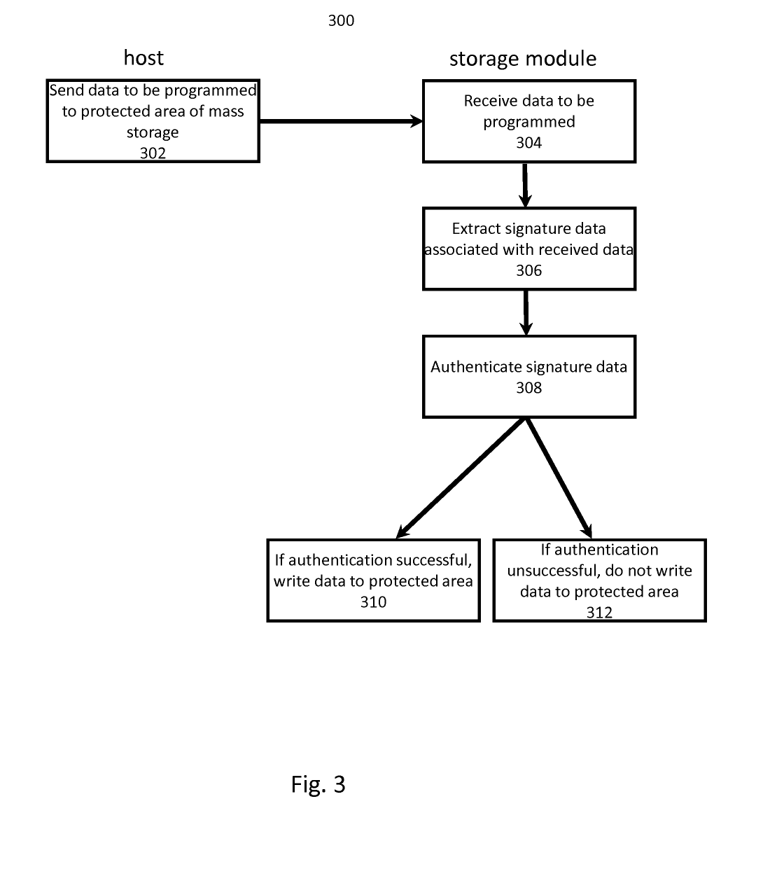

FIG. 3 depicts an exemplary process 300 for implementing a first embodiment of the invention. The process is illustrated as a logical flow graph, which represents a sequence of operations that can be implemented in hardware, software, or a combination thereof. The operations may represent executable instructions that, when executed by one or more processors, perform the recited operations. Executable instructions may include routines, programs, objects, components, modules, data structures, and the like that perform particular functions. The order in which the operations are described is not intended to be construed as a limitation, and any number of the described operations can be combined in any order and/or in parallel to implement the process. The executable instructions may be stored on computer storage media including volatile and non-volatile, removable and non-removable media implemented in any method or technology for storage of information such as computer readable instructions, data structures, program modules, or other data. Computer storage media includes, but is not limited to, random-access memory (RAM), read-only memory (ROM), electrically erasable programmable read-only memory (EEPROM), flash memory or other memory technology, magnetic storage devices, or any other non-transmission medium that can be used to store information for access by a host device or by a storage module.

In step 302, host 100 sends data to be programmed or written to a protected area (e.g., region or portion of memory) of mass storage 202. This step may take the form of a standard write command with specialized arguments to inform storage module 120 that a write to a protected area is requested. Other alternatives for this step include, but are not limited to, specialized commands or a generic command that storage module 120 detects to be for a protected area based on the destination address of the write command. Registers 212 may define a region of memory, either logical or physical, of storage module 120 and the type of protection that the region receives or a type of protection that is to be applied to the region. For example, a register may define the region as a function of physical or logical addresses, partition(s), blocks, etc., and another register may define the type of protection, e.g., with 2-bits: ‘00’ means no protection, ‘01’ means temporary write protection that is cleared when the power of the storage module is cycled, ‘10’ means authenticated protection that means writes are only allowed if the data is authenticated (e.g., against a key), and ‘11’ means that the region is permanently protected against all writes. If the region is authenticated write protected (e.g., 2-bits specifying ‘10’ as discussed above), then the authentication of the data to be written or programmed must be verified before the data is written or programmed to the region.

In various implementations, prior to sending the data, the host 100 may sign the data to be written or programmed with a data signature. For example, the data may be signed by appending, e.g., to the data to be programmed or written, authentication data that is the result of performing a signature function on the data with a secret key that should be known only by those that are trusted to modify the region (e.g., the manufacturer of the host or storage module). Accordingly, a write access may include first data that the storage module may authenticate to verify that second data is to be programmed or written to a protected region. Optionally, the data to be written or programmed may also be encrypted using the same key or a different key. In some examples, the signature data may be based on both the data to be programmed or written and the key so that the signature data can be authenticated by an entity that knows the key. One such method of signing (and authenticating data) may be found in JEDEC Standard No. JESD84-B451, published June 2012, which is incorporated by reference in its entirety. Specifically, section 6.6.22.4.3 describes one example method for signing data.

In step 304, the data to be programmed or written to the protected area (e.g., a region of memory) is received at storage module 120. The data may be stored in a temporary area of mass storage 202, or alternatively, the data may be authenticated prior to all of the data being received at storage module 120. Once authenticated, the data may be stored directly to the protected area of mass storage 202 without having to use a temporary write location.

In step 306, after receiving all of the data, or in some cases, some portion of the data, the signature data associated with the data or portion of the data is extracted, e.g., from the received data. The previously referenced JEDEC Standard No. JESD84-B451 describes one exemplary method of performing this step.

In step 308, once the signature data is extracted, the signature data is authenticated. This may require having received both the signature data and all of the data that is to be programmed or written to the region. For example, storage controller 200 may have circuitry (e.g., within control circuit 204) that recalculates the signature data based on a secret key that is stored within storage module 120 during manufacturing, e.g., of the storage module 120 and/or the host 100. If the signature data from 306 matches the recalculated signature data, then the received data to be programmed or written may be considered authorized or verified since only the manufacturer knows the secret key.

In step 310, if the data is successfully authenticated, then the data is programmed or written to the protected area (e.g., the region of memory). Alternatively, if the received data is encrypted, then the unencrypted data is programmed or written to the protected area. The data may be written as an atomic write that ensures either none or all of the data is written.

In step 312, if the data is not successfully authenticated, then the data is not programmed or written to the protected area (e.g., the region of memory is protected from having any data written to it). Storage module 120 may raise an error to host 100 indicating the authentication failure.

In a second embodiment, a register defines a region of memory that is protected, similar to as described with respect to the first embodiment. However, instead of authorizing a write to the protected region of memory, authentication of the data clears (either temporarily or permanently) a register that contains a protection bit or bits for the protected region of memory, thereby allowing for writing the data to the protected region of memory. The data may be written as an atomic write that ensures either none or all of the data is written. Once the data is programmed or written to the region, the write protection may be restored either automatically or through further commands.

Embodiments of the present disclosure include a storage device, comprising means for storing data, such as for example addressable memory locations in mass storage 202. The storage device comprises means for defining a logical portion of storage as authenticated write protected, such as for example one or more of registers 212A-212H. The storage device further comprises means for receiving first data and second data, such as for example data in line 216b and data terminal 216a. The storage device even further comprises means for authenticating the first data and for enabling writing of the second data to the logical portion of the storage after the authentication of the first data, such as for example the storage controller 200.

Although a feature may appear to be described in connection with a particular embodiment, one skilled in the art would recognize that various features of the described embodiments may be combined. Moreover, aspects described in connection with an embodiment may stand alone.

1. A storage device comprising:
a plurality of addressable memory locations, each addressable memory location of the plurality of addressable memory locations having at least one memory cell, the plurality of addressable memory locations collectively forming a storage;
one or more registers for defining a logical portion of the storage as authenticated write protected;
a receiver for receiving first data and second data; and
at least one controller for authenticating the first data, and for enabling writing of the second data to the logical portion of the storage after the authentication of the first data.

2. The storage device according to claim 1, wherein enabling writing of the second data to the logical portion of the storage comprises clearing one or more protection bits associated with the one or more registers.

3. The storage device according to claim 2, wherein, in response to a failure to authenticate the first data, the at least one controller does not clear the one or more protection bits.

4. The storage device according to claim 2, wherein in response to the clearing the one or more protection bits, the at least one controller receives at least a portion of the second data to be stored in the logical portion of the storage.

5. The storage device of claim 1, wherein the first data comprises signature data.

6. The storage device according to claim 1, wherein the authenticating of the first data comprises authenticating the first data based at least in part on a key.

7. The storage device according to claim 6, wherein the key is associated with the logical portion of the storage and the key is stored within the storage device during manufacturing of a host device operatively connected to the storage device.

8. The storage device according to claim 1, wherein the storage device comprises a Universal Flash Storage (UFS) module.

9. The storage device according to claim 1, wherein the storage device comprises an embedded MultiMediaCard (eMMC).

10. One or more computer storage media comprising instructions that, when executed, configure a storage device to:
define a logical portion of a storage as authenticated write protected;
receive first data and second data from a host device;
authenticate the first data; and
enable writing of the second data to the logical portion of the storage after the authentication of the first data.

11. The one or more computer storage media according to claim 10, wherein enabling writing of the second data to the logical portion of the storage comprises clearing one or more protection bits that define the logical portion of the storage as being authenticated write protected.

12. The one or more computer storage media according to claim 11, further comprising, in response to a failure to authenticate the first data, not clearing the one or more protection bits.

13. The one or more computer storage media according to claim 11, further comprising, in response to the clearing the one or more protection bits, receiving at least a portion of the second data to be stored in the logical portion of the storage.

14. The one or more computer storage media according to claim 10, wherein the first data comprises signature data.

15. The one or more computer storage media according to claim 10, wherein the authenticating of the first data comprises authenticating the first data based at least in part on a key.

16. The one or more computer storage media according to claim 15, wherein the key is associated with the logical portion of the storage and the key is stored within the storage device during manufacturing of a host device operatively connected to the storage device.

17. The one or more computer storage media according to claim 10, wherein the storage device comprises a Universal Flash Storage (UFS) module.

18. The one or more computer storage media according to claim 10, wherein the storage device comprises an embedded MultiMediaCard (eMMC).

19. A computer-implemented method comprising:
defining, by one or more storage controllers, a logical portion of a storage associated with a storage device as authenticated write protected;
receiving, by one or more storage controllers, first data and second data from a host device;
authenticating, by one or more storage controllers, the first data; and
enabling, by one or more storage controllers, writing of the second data to the logical portion of the storage after the authentication of the first data.

20. The computer-implemented method according to claim 19, wherein enabling writing of the second data to the logical portion of the storage comprises clearing one or more protection bits that define the logical portion of the storage as being authenticated write protected.

21. The computer-implemented method according to claim 20, further comprising, in response to a failure to authenticate the first data, not clearing the one or more protection bits.

22. The computer-implemented method according to claim 20, further comprising, in response to the clearing the one or more protection bits, receiving at least a portion of the second data to be stored in the logical portion of the storage.

23. The computer-implemented method according to claim 19, wherein the first data comprises signature data.

24. The computer-implemented method according to claim 19, wherein the authenticating of the first data comprises authenticating the first data based at least in part on a key.

25. The computer-implemented method according to claim 24, wherein the key is associated with the logical portion of the storage and the key is stored within the storage device during manufacturing of a host device operatively connected to the storage device.

26. The computer-implemented method according to claim 19, wherein the storage device comprises a Universal Flash Storage (UFS) module.

27. The computer-implemented method according to claim 19, wherein the storage device comprises an embedded MultiMediaCard (eMMC).

28. A host device comprising a host controller for sending first data and second data to a storage device, wherein the first data comprises signature data that, in response to authentication by the storage device, enables writing of the second data to a logical portion of a storage associated with the storage device.

29. The host device according to claim 28, wherein the host device signs the first data to generate the signature data based at least in part on use of a key.

30. The host device according to claim 29, wherein the key is stored within the host device during manufacturing of the host device.

31. A storage device comprising:
a plurality of addressable memory locations, each addressable memory location of the plurality of addressable memory locations having at least one memory cell, the plurality of addressable memory locations collectively forming a storage;
one or more registers for defining a logical portion of the storage as authenticated write protected;
a receiver for receiving first data and second data;
at least one controller for authenticating the first data based at least in part on a key,
wherein in response to a successful authentication, the at least one controller clears one or more protection bits associated with the one or more registers, and
wherein in response to the clearing the one or more protection bits, writing of the second data to the logical portion of the storage is enabled.
